(19) United States
(12) Patent Application Publication
(10) Pub. No.: US 2026/0297298 A1
(43) Pub. Date: Oct. 1, 2026

(54) COMPOSITE MATERIAL AND LENS MODULE

(71) Applicant: INDUSTRIAL TECHNOLOGY RESEARCH INSTITUTE, Hsinchu (TW)

(72) Inventors: Hung-Jen LIU, Hsinchu City (TW); Hsin-Ching KAO, Baoshan Township (TW); Po-Hsien HO, Taipei City (TW)

(73) Assignee: INDUSTRIAL TECHNOLOGY RESEARCH INSTITUTE, Hsinchu (TW)

(21) Appl. No.: 19/671,525

(22) Filed: May 8, 2026

Related U.S. Application Data
(62) Division of application No. 18/168,619, filed on Feb. 14, 2023.
(60) Provisional application No. 63/333,643, filed on Apr. 22, 2022.

(30) Foreign Application Priority Data
Jan. 6, 2023 (TW) 112100499

(51) Int. Cl. C08K 7/00; C08G 69/26; C08G 69/36; C08L 77/06; G02B 7/02

(52) U.S. Cl. CPC C08K 7/00; C08G 69/26; C08G 69/36; C08L 77/06; G02B 7/02; C08K 2201/016

(57) ABSTRACT

A composite material is provided. The composite material includes (a1) first polyamide polymerized from C₁₀₋₁₂ diamine and terephthalic acid or an ester thereof, or (a2) second polyamide polymerized from C₈₋₁₂ diamine, terephthalic acid or an ester thereof, and 4-aminoalkyl benzoic acid or an ester thereof; and (b) sheet-shaped material having an average aspect ratio of 40 to 80. The composite material can be used in the lens base and the barrel of a lens module.

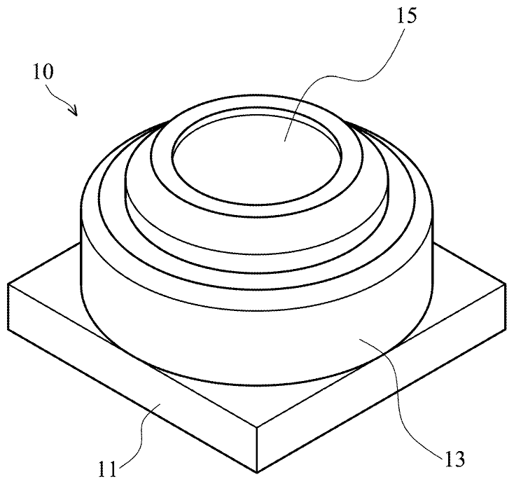

### CROSS REFERENCE TO RELATED APPLICATIONS

This application is a Divisional of U.S. patent application Ser. No. 18/168,619, filed on Feb. 14, 2023 and entitled “COMPOSITE MATERIAL AND LENS MODULE”, which claims the benefit of U.S. Provisional Application No. 63/333,643, filed on Apr. 22, 2022, and claims priority of Taiwan Patent Application No. 112100499, filed on Jan. 6, 2023, the entirety of which are incorporated by reference herein.

### TECHNICAL FIELD

The technical field relates to a composite material, and in particular it relates to a lens module utilizing the composite material.

### BACKGROUND

The high water absorption of conventional polyamide PA6 and PA66 leads to problems such as lowering the rigidity and size stability after long-term use, thereby limiting their industrial applications. The international industry has developed high-grade long carbon chain semi-aromatic polyamide materials (such as PA9T or PA10T), which are temperature-resistant and low-moisture-absorbing to expand the downstream high-value industrial applications. Taking the LED industry as an example, polyamide PA9T or PA10T is mainly used in the reflector cup of LED injection lead frames (illumination/display).

A reinforcing material can be added into the polyamide material to enhance the physical properties of the material. PA10T has a higher melting point than PAST, and the reinforcing material is more difficult to disperse in PA10T. Accordingly, a suitable reinforcing material for dispersal in the polyamide is called for to enhance the physical properties of the composite material.

### SUMMARY

One embodiment of the disclosure provides a composite material, including (a1) first polyamide polymerized from C₁₀₋₁₂ diamine and terephthalic acid or an ester thereof, or (a2) second polyamide polymerized from C₈₋₁₂ diamine, terephthalic acid or an ester thereof, and 4-aminoalkyl benzoic acid or an ester thereof; and (b) sheet-shaped material having an aspect ratio of 40 to 80.

One embodiment of the disclosure provides a lens module, including a lens base; a barrel disposed on the lens base; and a lens disposed in the barrel, wherein the lens base, the barrel, or both are formed of a composite material, wherein the composite material includes (a1) first polyamide polymerized from C₁₀₋₁₂ diamine and terephthalic acid or an ester thereof, or (a2) second polyamide polymerized from C₈₋₁₂ diamine, terephthalic acid or an ester thereof, and 4-aminoalkyl benzoic acid or an ester thereof, and (b) sheet-shaped material having an aspect ratio of 40 to 80.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGURE shows a lens module in one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

One embodiment of the disclosure provides a composite material, including long alkyl chain and semi-aromatic nylon polymer and a sheet-shaped material. For example, the composite material includes (a1) first polyamide polymerized from C₁₀₋₁₂ diamine and terephthalic acid or an ester thereof, or (a2) second polyamide polymerized from C₈₋₁₂ diamine, terephthalic acid or an ester thereof, and 4-aminoalkyl benzoic acid or an ester thereof; and (b) sheet-shaped material having an aspect ratio of 40 to 80. In other words, the composite material in some embodiments may include (a1) first polyamide and (b) sheet-shaped material (i.e. (a1)+(b)). The composite material in some embodiments may include (a2) second polyamide and (b) sheet-shaped material (i.e. (a2)+(b)). In some embodiments, the sheet-shaped material may include muscovite, sericite, wollastonite, kaolinite, or a combination thereof. In some embodiments, the sheet-shaped material may have an aspect ratio of 40 to 80, such as 40 to 70, or 40 to 60. If the aspect ratio of the sheet-shaped material is too small or too large, the composite material cannot have sufficient low perpendicular shrinkage (TD), parallel shrinkage (MD), and TD/MD ratio. In some embodiments. The sheet-shaped material is 0.1 micrometers to 10 micrometers in thickness. If the thickness of the sheet-shaped material is too small, the sheet-shaped material will be easily aligned, thereby resulting a large difference between the perpendicular shrinkage and the parallel shrinkage of the composite material. If the thickness of the sheet-shaped material is too large, the reinforcing effect will be poor.

Note that the size of the sheet-shaped material (e.g. thickness and aspect ratio) means the size of the sheet-shaped material after being compounded with the polyamide other than the size of the sheet-shaped material before being compounded with the polyamide. In general, the size of the sheet-shaped material (after being compounded with the polyamide to form the composite material) in the composite material is different from the size of the original sheet-shaped material. Some sheet-shaped material (such as nano silicon particles having a high aspect ratio) may aggregate after being compounded with the polyamide to form the composite material, which cannot improve the properties of the composite material. Unless otherwise specified, the size of the sheet-shaped material refers to the size of the sheet-like material in the composite material, rather than the size of the original sheet-like material before compounding.

In some embodiments, weight of (a1) first polyamide or (a2) second polyamide and weight of (b) sheet-shaped material have a weight ratio of 50:50 to 90:10. If the amount of the sheet-shaped material is too high, the sheet-shaped material cannot be dispersed and will be precipitated from the polyamide. If the amount of the sheet-shaped material is too low, the composite material will not have a sufficient low perpendicular shrinkage (TD), a sufficient low parallel shrinkage (MD), and a sufficient low TD/MD ratio.

In some embodiments, (a1) first polyamide is polymerized from C₁₀₋₁₂ diamine and terephthalic acid or an ester thereof, and has a chemical structure of

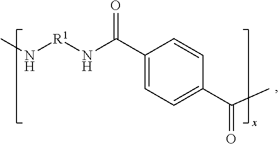

wherein R¹ is C₁₀₋₁₂ linear alkylene group, and x is a repeating number. For example, R¹ can be n-decylene group, n-undecylene group, or n-dodecylene group.

In some embodiments, (a2) second polyamide is polymerized from C₈₋₁₂ diamine, terephthalic acid or an ester thereof, and 4-aminoalkyl benzoic acid or an ester thereof, and has a chemical structure of

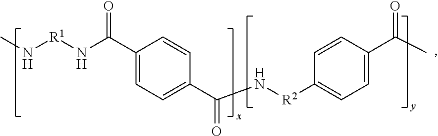

wherein R¹ is C₈₋₁₂ linear alkylene group, R² is C₁₋₃ alkylene group, x and y are repeating numbers, and x and y may have a ratio of 99:1 to 80:20. For example, R¹ can be n-octylene group, n-nonenylene group, n-decylene group, n-undecylene group, or n-dodecylene group. R² can be methylene group, ethylene group, or propylene group. If y is too high, the melting point of the polyamide will be too low (e.g. lower than 260° C.) and the thermal stability of the polyamide will be insufficient. In some embodiments, x and y have a ratio of 90:10 to 80:20.

In some embodiments, (a1) first polyamide or (a2) second polyamide has an intrinsic viscosity of 0.75 dL/g to 0.95 dL/g at 25° C. The molecular weight of the polyamide is positively correlated to the intrinsic viscosity of the polyamide, and the higher molecular weight means the higher intrinsic viscosity. If the intrinsic viscosity of the polyamide is too low, the molecular weight of the polyamide will be too low, thereby resulting in a poor mechanical strength and a too low melting viscosity of the material. If the intrinsic viscosity of the polyamide is too high, the molecular weight of the polyamide will be too high, thereby resulting a too high melting viscosity of the material (i.e. difficult to be injection molded).

In some embodiments, the composite material may have a perpendicular shrinkage (TD) of 0.01% to 1% and a parallel shrinkage (MD) of 0.01% to 1%. In addition, the composite material may have a ratio of the perpendicular shrinkage to the parallel shrinkage (TD/MD) of 1 to 1.5. If the composite material has a too high perpendicular shrinkage (TD), a too high parallel shrinkage (MD), or a too high TD/MD ratio, the processing molding yield of the composite material will be insufficient.

In some embodiments, the composite material may further include another additive such as antioxidant, lubricant, or the like to modify the physical properties of the composite material.

The composite material in some embodiments of the disclosure can be applied as components such as a lens base or a barrel of a lens module in a cell phone. As shown in FIGURE, the lens module 10 includes a lens base 11 and a barrel 13 disposed on the lens base 11. In one embodiment, the lens base 11 and the barrel 13 can be molded as one piece of the above composite material. Alternatively, the lens base 11 and the barrel 13 are respectively formed and then assembled, and the lens base 11, the barrel 13, or both may be formed of the composite material. A lens 15 can be disposed in the barrel 13. It should be understood that the lens module 10 is only for illustration, and one skilled in the art may utilize the composite material of the disclosure to serve as any lens base and barrel in any lens module, which is not limited to the lens module shown in FIGURE. In addition, the composite material of the disclosure is not only utilized in the lens module but also a high-end surface mount technology (SMT) connector for a 5G base station, a high-brightness LED automobile light reflector, electric vehicle servomotor coupling, or the like.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

In following Examples, the intrinsic viscosity of the polyamide was measured according to the standard ASTM D4603. The size such as length, width, and thickness of the sheet-shaped material in the composite material were obtained by observing the SEM photograph to calculate the aspect ratio of the sheet-shaped material in the composite material. The perpendicular shrinkage (TD) and the parallel shrinkage (MD) of the composite were measured according to the standard ASTM D955 to calculate the ratio of perpendicular shrinkage to the parallel shrinkage (TD/MD).

In the following Examples, the sheet-shaped muscovite SYA-21R (commercially available from Yamaguchi Mica Co., Ltd.) before being compounded with polyamide had a length of about 5 micrometers to 50 micrometers, a width of about 5 micrometers to 50 micrometers, a thickness of about 0.1 micrometers to 1 micrometer, and an aspect ratio of greater than 50. In the following Examples, the nano silicon particles NSP (Natural silicate platelets commercially available from J & A Technology Corporation) before being compounded with the polyamide had a length of about 100 nm, a width of about 100 nm, a thickness of about 1 nm, and an aspect ratio of about 100.

### Comparative Example 1

Polyamide PA10T (H101, commercially available from Wison) was selected to measure its intrinsic viscosity at 25° C. (0.80 g/DL), perpendicular shrinkage (TD, 3.54%), and parallel shrinkage (MD, 1.23%). The polyamide PA10T had TD/MD ratio of 2.87. Accordingly, the perpendicular shrinkage (TD), the parallel shrinkage (MD), and TD/MD ratio of the polyamide PA10T were too high. The polyamide PA10T had a chemical structure of

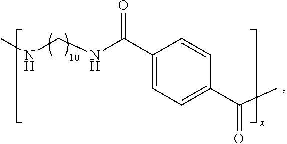

and x is a repeating number.

### Example 1

65 parts by weight of the commercially available polyamide PA10T (H101 commercially available from Wison) and 35 parts by weight of the sheet-shaped muscovite were compounded to form a composite material (e.g. baking dried at 80° C. for 4 hours, and then compounded and injected at 325° C. by a micro twin-screw extruder to form a standard sample). The sheet-shaped muscovite in the composite material had a length of 13 micrometers to 20 micrometers, a thickness of 0.3 micrometers to 0.4 micrometers, and an average aspect ratio of 42. The composite material had a perpendicular shrinkage (TD) of 0.38%, a parallel shrinkage (MD) of 0.31%, and a TD/MD ratio of 1.22. Accordingly, the sheet-shaped muscovite could make the composite material have a lower perpendicular shrinkage (TD), a lower parallel shrinkage (MD), and a lower TD/MD ratio.

### Example 2

138 g of decanediamine (0.80 mole), 133 g of terephthalic acid (0.80 mole), 60 g of 4-aminomethylbenzoic acid (0.40 mole), 0.9 g of benzoic acid, 0.33 g of sodium hypophosphite, and 110 g of deionized water (monomer solid content was 75%) were mixed and heated to 220° C. to react at constant pressure and constant temperature for 2 hours, then heated to 230° C. to react at constant pressure (25 kg/cm²) and constant temperature for 2 hours, slowly decompressed for 30 minutes to 10 kg/cm² to react further 30 minutes, and then cooled down to obtain a nylon prepolymer. The nylon prepolymer was dried in a circulation oven at 80° C. The dried nylon prepolymer was solid state polymerized under a nitrogen flow of 0.6 LPM to 0.8 LPM, which was heated to 210° C. and polymerized at 210° C. for 3 hours, then heated to 230° C. and polymerized at 230° C. for 21 hours, and then cooled down to obtain a polyamide PA10TX. Its intrinsic viscosity was measured at 25° C. (0.81 dL/g). The polyamide had a chemical structure of,

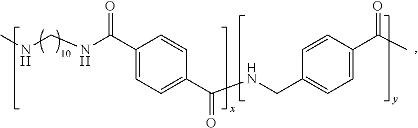

wherein x and y are repeating numbers, and x:y=80:20.

65 parts by weight of the polyamide PA10TX and 35 parts by weight of the sheet-shaped muscovite were compounded to form a composite material (e.g. baking dried at 80° C. for 4 hours, and then compounded and injected at 325° C. by a micro twin-screw extruder to form a standard sample). The sheet-shaped muscovite in the composite material had a length of 13 micrometers to 20 micrometers, a thickness of 0.3 micrometers to 0.4 micrometers, and an average aspect ratio of 50. The composite material had a perpendicular shrinkage (TD) of 0.40%, a parallel shrinkage (MD) of 0.27%, and a TD/MD ratio of 1.48. Accordingly, the sheet-shaped muscovite could make the composite material have a lower perpendicular shrinkage (TD), a lower parallel shrinkage (MD), and a lower TD/MD ratio.

### Comparative Example 2

65 parts by weight of the commercially available polyamide PA10T (H101 commercially available from Wison) and 35 parts by weight of the needle-shaped mica were compounded to form a composite material (e.g. baking dried at 80° C. for 4 hours, and then compounded and injected at 325° C. by a micro twin-screw extruder to form a standard sample). The needle-shaped mica (ST-3000 commercially available from SUNSHINE MINERAL COMPANY) before being compounded with the polyamide had a length of about 25 micrometers, a width of about 25 micrometers, a thickness of about 1 micrometer, and an aspect ratio of about 25. The needle-shaped mica in the composite material had a length of 4 micrometers to 14 micrometers, a thickness of 0.45 micrometers to 1 micrometer, and an average aspect ratio of 18. The composite material had a perpendicular shrinkage (TD) of 3.14%, a parallel shrinkage (MD) of 1.11%, and a TD/MD ratio of 2.82. Accordingly, the needle-shaped (not sheet-shaped) mica could not make the composite material have a lower perpendicular shrinkage (TD), a lower parallel shrinkage (MD), and a lower TD/MD ratio.

### Comparative Example 3

A commercially available composite material LA-121 included 65 wt % of polyamide PA9T and 35 wt % of needle-shaped mineral fiber. The polyamide PA9T had a chemical structure of

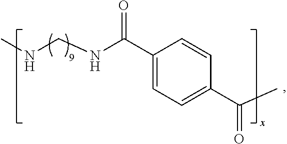

and x is a repeating number. The needle-shaped mineral fiber in the composite material had a length of 10 micrometers to 30 micrometers, a thickness of 0.9 micrometers to 1.0 micrometer, and an aspect ratio of 20. The composite material had a perpendicular shrinkage (TD) of 2.06%, a parallel shrinkage (MD) of 0.55%, and a TD/MD ratio of 3.74. Accordingly, the needle-shaped (not sheet-shaped) mineral fiber could not make the composite material have a lower perpendicular shrinkage (TD), a lower parallel shrinkage (MD), and a lower TD/MD ratio.

### Comparative Example 4

65 parts by weight of the commercially available polyamide PA9T (N1000A commercially available from Kuraray Genestar, Japan) and 35 parts by weight of the sheet-shaped muscovite were compounded to form a composite material (e.g. baking dried at 80° C. for 4 hours, and then compounded and injected at 325° C. by a micro twin-screw extruder to form a standard sample). The sheet-shaped muscovite in the composite material had a length of 7 micrometers to 18 micrometers, a thickness of 0.3 micrometers to 0.4 micrometers, and an average aspect ratio of 39. The composite material had a perpendicular shrinkage (TD) of 0.79%, a parallel shrinkage (MD) of 0.47%, and a TD/MD ratio of 1.68. Accordingly, if the sheet-shaped muscovite in the composite material had an insufficient aspect ratio, the composite material would have a too high TD/MD ratio. The polyamide PA9T had a chemical structure of

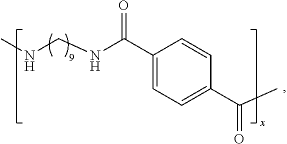

and x is a repeating number.

### Comparative Example 5

70 parts by weight of the commercially available polyamide PA9T (N1000A), 20 parts by weight of the sheet-shaped muscovite, and 10 parts by weight of the nano silicon particles (NSP) were compounded to form a composite material (e.g. baking dried at 80° C. for 4 hours, and then compounded and injected at 325° C. by a micro twin-screw extruder to form a standard sample). The sheet-shaped material in the composite material was not dispersed well due to partial aggregation. The composite material had a perpendicular shrinkage (TD) of 1.19%, a parallel shrinkage (MD) of 0.69%, and a TD/MD ratio of 1.72. Accordingly, if the sheet-shaped material was not dispersed well due to aggregation, the composite material would have a too high perpendicular shrinkage and a too high TD/MD ratio.

### Comparative Example 6

75 parts by weight of the commercially available polyamide PA9T (N1000A), 20 parts by weight of the sheet-shaped muscovite, and 5 parts by weight of the nano silicon particles (NSP) were compounded to form a composite material (e.g. baking dried for 4 hours, and then compounded and injected at 325° C. by a micro twin-screw extruder to form a standard sample). The sheet-shaped material in the composite material was not dispersed well due to partial aggregation. The composite material had a perpendicular shrinkage (TD) of 1.35%, a parallel shrinkage (MD) of 0.79%, and a TD/MD ratio of 1.71. Accordingly, if the sheet-shaped material was not dispersed well due to aggregation, the composite material would have a too high perpendicular shrinkage and a too high TD/MD ratio.

### Comparative Example 7

80 parts by weight of the commercially available polyamide PA9T (N1000A) and 20 parts by weight of the nano silicon particles (NSP) were compounded to form a composite material (e.g. baking dried at 80° C. for 4 hours, and then compounded and injected at 325° C. by a micro twin-screw extruder to form a standard sample). The sheet-shaped material in the composite material was not dispersed well due to partial aggregation. The composite material had a perpendicular shrinkage (TD) of 1.9%, a parallel shrinkage (MD) of 0.94%, and a TD/MD ratio of 2.02. Accordingly, if the sheet-shaped material was not dispersed well due to aggregation, the composite material would have a too high perpendicular shrinkage and a too high TD/MD ratio.

It will be apparent to those skilled in the art that various modifications and variations can be made to the disclosed methods and materials. It is intended that the specification and examples be considered as exemplary only, with the true scope of the disclosure being indicated by the following claims and their equivalents.

1. A composite material, comprising:
(a2) second polyamide polymerized from C₈₋₁₂ diamine, terephthalic acid or an ester thereof, and 4-aminoalkyl benzoic acid or an ester thereof; and
(b) sheet-shaped material having an average aspect ratio of 40 to 80.

2. The composite material as claimed in claim 1, wherein weight of (a2) second polyamide and weight of (b) sheet-shaped material have a ratio of 50:50 to 90:10.

3. The composite material as claimed in claim 1, wherein (b) sheet-shaped material has a thickness of 0.1 micrometers to 10 micrometers.

4. The composite material as claimed in claim 1, wherein (b) sheet-shaped material comprises muscovite, sericite, wollastonite, kaolinite, or a combination thereof.

5. The composite material as claimed in claim 1, wherein (a2) second polyamide has a chemical structure of 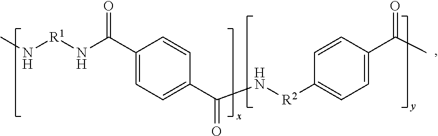
wherein R¹ is C₈₋₁₂ linear alkylene group, R² is C₁₋₃ alkylene group, x and y are repeating numbers, and x:y=99:1 to 80:40.

6. The composite material as claimed in claim 1, wherein (a2) second polyamide has an intrinsic viscosity of 0.75 dL/g to 0.95 dL/g at 25° C.

7. The composite material as claimed in claim 1, wherein the composite material has a perpendicular shrinkage of 0.01% to 1% and a parallel shrinkage of 0.01% to 1%.

8. The composite material as claimed in claim 1, wherein the composite material has a ratio of perpendicular shrinkage to parallel shrinkage of 1 to 1.5.

9. A lens module, comprising:
a lens base;
a barrel disposed on the lens base; and
a lens disposed in the barrel,
wherein the lens base, the barrel, or both are formed of a composite material,
wherein the composite material comprises
(a2) second polyamide polymerized from C₈₋₁₂ diamine, terephthalic acid or an ester thereof, and 4-aminoalkyl benzoic acid or an ester thereof; and
(b) sheet-shaped material having an average aspect ratio of 40 to 80.

10. The lens module as claimed in claim 9, wherein weight of (a2) second polyamide and weight of (b) sheet-shaped material have a ratio of 50:50 to 90:10.

11. The lens module as claimed in claim 9, wherein the composite material has a perpendicular shrinkage of 0.01% to 1% and a parallel shrinkage of 0.01% to 1%.

12. The lens module as claimed in claim 9, wherein the composite material has a ratio of perpendicular shrinkage to parallel shrinkage of 1 to 1.5.
